(19) United States
(12) Patent Application Publication
(10) Pub. No.: US 2013/0082814 A1
(43) Pub. Date: Apr. 4, 2013

(54) MULTI-WINDING MAGNETIC STRUCTURES

(71) Applicants: Piotr Markowski, Ansonia, CT (US); Andreas Stiedl, Giesshubl (AT)

(72) Inventors: Piotr Markowski, Ansonia, CT (US); Andreas Stiedl, Giesshubl (AT)

(21) Appl. No.: 13/250,377

(22) Filed: Sep. 30, 2011

(51) Int. Cl. H01F 27/36

(52) U.S. Cl. 336/215

(57) ABSTRACT

A parallel multi-winding magnetic structure includes a magnetic core defining a plurality of flux paths through the core and a plurality of windings extending around portions of the core. At least some of the windings are positioned adjacent a periphery of the structure. The structure further includes an electrical conductor extending along the periphery of the structure and the windings positioned adjacent the periphery of the structure.

### FIELD

The present disclosure relates to multi-winding magnetic structures.

### BACKGROUND

This section provides background information related to the present disclosure which is not necessarily prior art.

A transformer is a device that transfers electrical energy from one circuit to another through inductively coupled conductors. The inductively coupled conductors are the transformer's coils or windings.

In one form, a transformer has two galvanically separated coils. These coils are commonly referred to as a primary winding and a secondary winding. Designation as the primary winding is usually given to the winding that is galvanically connected to a source of energy or circuitry actively controlling electrical parameters. The secondary winding is typically the winding that is connected to a receiver of energy or a circuit passively responding to the actions of the primary circuitry. Of course, primary/secondary designations are typically not meaningful with respect to the transformer itself and are descriptive only for the role this transformer performs in the overall circuit. Primary and secondary windings work the same way as to the main principles of transformers. With a transformer with identical primary and secondary coils, for example, the coils can be interchanged without any impact on the operation of a circuit (or circuits) connected to such transformer. Interchanging the coils of a transformer having different primary and secondary coils would change voltage and current relationships, but would impact connected circuitry only, while the transformer itself would work the same way. Furthermore, the primary and secondary windings may be connected, used, etc. in ways other than common transformers, rendering the primary and secondary terminology meaningless (and possibly confusing). Terminology becomes even more confusing with transformers having multiple windings, including, for example, magnetic structures as disclosed in the present application. Therefore, numerical designations for various windings (instead of primary-secondary) will typically be used herein.

FIG. 1 illustrate a two winding transformer, generally indicated by the reference numeral 100, along with the voltages V1, V2 across the windings of the transformer 100 and the currents I1, I2 through the windings of the transformer 100. To improve energy transfer between windings, a highly magnetic (high permeability) material is commonly used as a transformer core 102. This core 102 provides a low reluctance path for the magnetic field, passing through both windings, such that nearly all of the magnetic field is enclosed by the first and second coils. The relationship between voltages and currents in a two winding transformer (e.g., transformer 100) is determined by the ratio of the number of turns N1 of the first winding to the number of turns N2 of the second winding (i.e., the turns ratio). The relationship may be expressed mathematically as

$$\frac{V 1}{V 2} = \frac{- I 2}{I 1} = \frac{N 1}{N 2} \qquad ( 1 )$$

An example of a transformer 200 with more than two windings is shown in FIG. 2. Such transformers are commonly used in utility line frequency applications (50/60 Hz), and in high frequency switched mode power supplies. The transformer 200 includes a first, a second and a third winding having N1, N2 and N3 turns respectively. The voltages across the first, second and third windings are V1, V2 and V3, respectively, and the currents entering the first, second and third windings are I1, I2 and I3, respectively. The transformer 200 is commonly called a series multi-winding transformer.

The relationship between voltages and currents for transformer 200 (and for other transformers having more than two windings) differs from the relationship between voltages and currents for two winding transformer (e.g., transformer 100). The voltages across all three windings of transformer 200 are related by the turns ratios in the same manner as a two winding transformer (e.g., transformer 100). Namely, the voltage relationships are governed by the equation:

$$\frac{V 1}{N 1} = \frac{V 2}{N 2} = \frac{V 3}{N 3} \qquad ( 2 )$$

However, the current relationship for a two winding transformer (e.g., 100) expressed in equation (1) is not valid in the case of transformer 200. Knowing the current of one of the windings and the turns ratios does not allow determination of the current of the other windings. Instead, the sum of ampere-turn products of all windings must be equal to zero. Mathematically this rule is expressed as:

$${\sum }_{k = 1}^{n} Ik * Nk = 0 \qquad ( 3 )$$

A parallel multi-winding transformer 300 is shown in FIG. 3. The transformer 300 includes a first, a second and a third winding having N1, N2 and N3 turns, respectively. The voltages across the first, second and third windings are V1, V2 and V3, respectively, and the currents at the beginning of the first, second and third windings are I1, I2 and I3, respectively.

Parallel multi-winding transformer 300 is characterized by a deterministic current relationship between any two windings:

I1*N1=I2*N2=I3*N3 (4)

However, the law for the voltages for parallel multi-winding transformer 300 reflects a weaker interrelationship given by:

$${\sum }_{k = 1}^{n} \frac{Vk}{Nk} = 0 \qquad ( 5 )$$

Transformer 300 may be used for power sources where output current is controlled (rather than output voltage) or where equal current distribution in multiple branches of the circuit is desired for more accurate operation or stress reduction.

The relationships presented above, e.g., equations (2)-(5), demonstrate the difference between series multi-winding transformers and parallel multi-winding transformers. These relationships do not include the effect of various non-ideal properties of the transformers, as the non-ideal properties are generally irrelevant for illustration of the differences between these two structures

One non-ideal property of transformers that is important in some applications, including, for example, high frequency applications, is leakage inductance. Leakage inductance represents energy stored in the magnetic field that is not coupled between various windings. Leakage inductance manifests itself as if an uncoupled inductor was placed in series with the transformer winding. This inductor creates additional impedance, which may interfere with the operation of the circuit.

Various techniques for constructing transformers with low leakage inductance are known. These known techniques are commonly based on physical arrangement of the core and the windings with different windings placed as close to one to another as possible. Two of the techniques for constructing transformers with low leakage inductance are interleaving and multifilar winding. In interleaving, windings are divided into multiple sections arranged in alternate layers. In multifilar winding, more than one winding is wound on a core using isolated multistrand wires.

These known techniques for constructing low leakage inductance transformers, however, are typically applicable only to series multi-winding transformers, as the techniques require different windings to be placed physically on the same part of a core. This kind of physical proximity generally may not be used for a parallel multi-winding transformer, as it is not compatible with its structure.

### SUMMARY

This section provides a general summary of the disclosure, and is not a comprehensive disclosure of its full scope or all of its features.

According to one aspect of the present disclosure, a parallel multi-winding magnetic structure includes a magnetic core defining a plurality of flux paths through the core and a plurality of windings extending around portions of the core. At least some of the windings are positioned adjacent a periphery of the structure. The structure further includes an electrical conductor extending along the periphery of the structure and the windings positioned adjacent the periphery of the structure.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an isometric view of a prior art two winding transformer.

FIG. 2 is an isometric view of a prior art series multi-winding transformer.

FIG. 3 is an isometric view of a prior art parallel multi-winding transformer.

FIG. 4 is an isometric view of an example core for a parallel multi-winding magnetic structure according to an aspect of this disclosure.

FIG. 5 is a cross sectional view of a portion of an example parallel multi-winding magnetic structure including the core of FIG. 4

FIG. 6 is an isometric view of an example parallel multi-winding magnetic structure according to various aspects of this disclosure.

FIG. 7 is a cross sectional view of a portion of the parallel multi-winding magnetic structure of FIG. 6.

FIG. 8 is a front view of an example parallel multi-winding magnetic structure according to various aspects of this disclosure.

FIG. 9 is a cross sectional view of a portion of the parallel multi-winding magnetic structure of FIG. 8.

FIG. 10 is a cross sectional view of a portion of an example parallel multi-winding magnetic structure illustrating windings according to this disclosure that are wound differently than the windings in the parallel multi-winding magnetic structure of FIG. 9.

FIG. 11 is a cross sectional view of a portion of an example parallel multi-winding magnetic structure illustrating windings according to this disclosure that are wound differently than the windings in the parallel multi-winding magnetic structure of FIGS. 9 and 10.

FIGS. 12A-12F are sectional views of various column configurations for cores of parallel multi-winding magnetic structures according to this disclosure.

FIG. 13 is an isometric view of a core with eight columns for an example parallel multi-winding magnetic structure according to various aspects of this disclosure.

FIG. 14 is a cross sectional view of a portion of a parallel multi-winding magnetic structure including the core of FIG. 15.

FIG. 15 is an isometric view of an example core with sixteen columns for a parallel multi-winding magnetic structure according to aspects of this disclosure.

FIG. 16 is a top plan view of a parallel multi-winding magnetic structure including the core of FIG. 15 and sixteen windings with the core top removed.

FIG. 17 is an isometric view of the parallel multi-winding magnetic structure of FIG. 16 with the core top in place.

FIG. 18 is an isometric view of an example core with eight columns and a chamfered top and bottom for use in a parallel multi-winding magnetic structure according to aspects of this disclosure.

FIG. 19 is a side plan view of the example core of FIG. 18.

FIG. 20 is a cross sectional view of a portion of a parallel multi-winding magnetic structure including the core of FIG. 18.

FIG. 21A is a sectional view of the parallel multi-winding magnetic structure of FIGS. 15-17 illustrating magnetic fields.

FIG. 21B is a sectional view of a parallel multi-winding magnetic structure having an electrical conductor and including the core and the windings of FIGS. 15-17 illustrating magnetic fields.

FIG. 22 is an isometric view of a parallel multi-winding magnetic structure having electrical conductors and including the core and the windings of FIGS. 15-17.

FIG. 23 is a portion of a cross sectional view of the parallel multi-winding magnetic structure of FIG. 22.

FIG. 24 is a portion of a cross sectional view of a parallel multi-winding magnetic structure having electrical conductors according to an example embodiment.

FIG. 25 is a portion of a cross sectional view of a parallel multi-winding magnetic structure having electrical conductors according to another example embodiment.

FIG. 26 is a portion of a cross sectional view of a parallel multi-winding magnetic structure having electrical conductors according to yet another example embodiment.

FIGS. 27A-31 are circuit diagrams of parallel multi-winding magnetic structure having electrical conductors according to example embodiments.

FIGS. 32A-32I are sectional views of various column configurations for cores of parallel multi-winding magnetic structures having electrical conductors according to example embodiments.

FIG. 33 is a sectional view of two multi-winding magnetic structures having an electrical conductor according to an example embodiment.

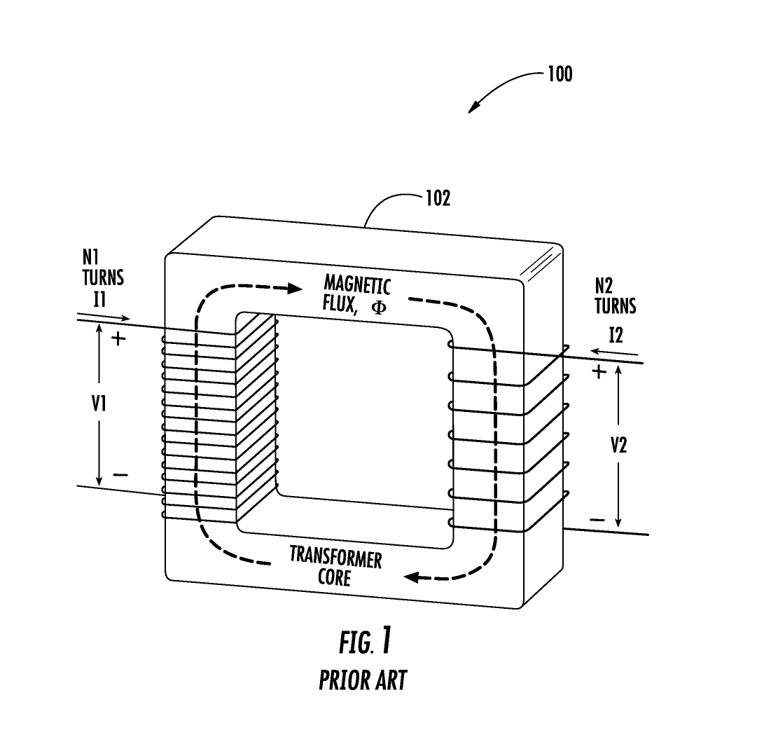

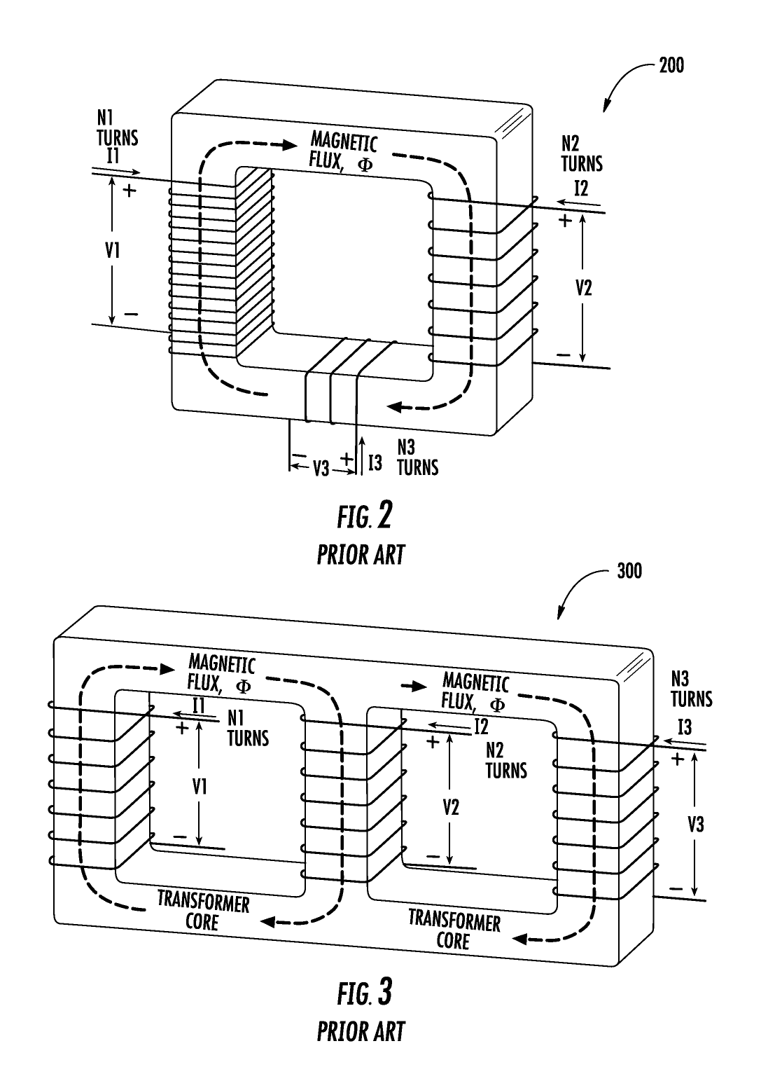

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

This disclosure describes multi-winding parallel magnetic structures and methods for making and designing such structures. The structures and techniques described herein may be used for multi-winding parallel transformers, multi-winding parallel inductors (e.g., non-isolated magnetic structures), chokes (e.g., inductors designed to carry significant DC bias) and autotransformers (e.g., transformers changing current/voltage relationship via inductive coupling without providing isolation). In this disclosure, the term multi-winding parallel magnetic structure will be used to cover any or all these structures. The techniques disclosed herein may be used individually or in any combination to produce a desired parallel multi-winding magnetic structure.

Low leakage inductance in a parallel multi-winding magnetic structure can be achieved by reducing the amount of energy stored in the part of the magnetic field that is associated with only one winding. This may be achieved by substantially minimizing the volume of space occupied by the uncoupled field.

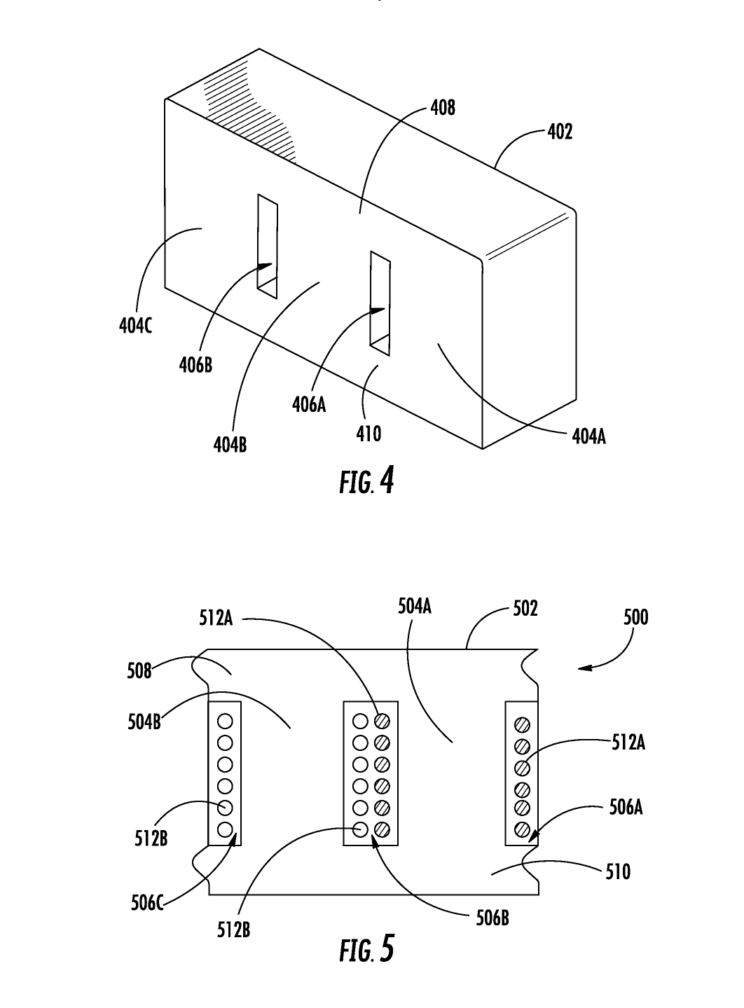

According to one aspect of the present disclosure, to reduce the leakage inductance of a parallel multi-winding magnetic structure, the ratio between the area used for the core and that used for the windings is substantially maximized. Examples incorporating this aspect are illustrated in FIGS. 4 and 5.

In embodiments of a parallel multi-winding magnetic structure constructed according to this aspect, the reluctance of the magnetic path through the core may be much lower than if the ratio were not maximized. The fields that exist in the core will tend to flow mostly through other parts of the core and will be coupled to other coils. In a standard transformer, the areas of the core and the winding are approximately equal and optimized such that the sum of core losses and winding losses is minimal. In embodiments of a parallel multi-winding magnetic structure according to this aspect, the ratio between the area of the core and the area of the winding is increased to the point where coupling is sufficient. This may be achieved by designing the parts of the core that provide a magnetic path for individual windings (sometimes called “columns” herein) with a large cross section area, while the space for windings between the columns (sometimes called “windows” or “winding windows” herein) is substantially minimized. In this way the volume of space occupied by the magnetic field that is coupled mostly to one winding window and not another window is minimized.

The width of the core for individual coils is at least two times the width of the winding window in one embodiment. In another embodiment, the ratio of the width of the core and the width of the winding window is at least three. In another embodiment, ratio of the width of the core to the width of the winding window is at least four. The ratio of the width of the core to the width of the winding window is not limited to any of the ratios described herein, and may be any ratio, whether more or less than the ratios expressed herein. Further, the ratio of the core for any one coil to the width of the winding window for that coil may be the same or different than the ratio of the core for any other coil to the width of the winding window for that coil.

An example core 402 for a parallel multi-winding magnetic structure is illustrated in FIG. 4. The core 402 includes three columns 404A-C (sometimes collectively referred to as columns 404) and two winding windows 406A, 406B (sometimes collectively referred to as winding windows 406). The columns 404 partly define the windows 406. For example, the width of the winding window 406A is defined by the distance between the opposing sides of column 404A and column 404B. Similarly, the width of the winding window 406B is defined by the distance between the opposing sides of column 404B and column 404C.

The core 402 includes a core top 408 and a core bottom 410. The core top 408 overlies the winding columns 404 and defines the top of the winding windows 406. The core bottom 410 underlies the columns 404 and defines the bottom of the winding windows 406. The core top 408 and core bottom 410 may be monolithically formed with the columns 404, may be separately formed parts attached to the columns 404, or a combination of the two (e.g., one of the core top 408 and core bottom 410 may be monolithically formed with the columns 404 and the other of the core top 408 and core bottom 410 may be separately formed and attached to the columns 404). Similarly, the core top 408 and the core bottom 410 may each be a single monolithically formed part, or may be constructed of more than one component, layer, etc.

In core 402 of FIG. 4, the ratio of the width of column 404 to the width of winding window 406 is relatively large. In this example embodiment, the ratio is about four (i.e., the width of each column 404 is about four times the width of each winding window 406).

FIG. 5 illustrates a cross-sectional view of a portion of a parallel multi-winding magnetic structure 500 according to another example embodiment. The structure 500 includes a core 502 and windings 512. The core 502 is similar to the core 402 in FIG. 4, but with differently proportions. The core 502 includes columns 504A, 504B and windows 506A-C. A core top 508 overlies the columns 504 and defines the top of the winding windows 506. The core bottom 510 underlies the columns 504 and defines the bottom of the winding windows 506. Winding 512A is wound around column 504A and passes through winding windows 506A and 506B. Winding 512B is wound around column 504B and passes through winding windows 506B and 506C. In the particular embodiment of FIG. 5, the ratio of the width of the column 504 to the width of the window 506 is about two.

According to another aspect of the present disclosure, the distance between windings of adjacent coils of a parallel multi-winding magnetic structure should be substantially minimized. Placing the windings as close as possible to each other helps reduce leakage inductance of the parallel multi-winding magnetic structure.

According to still another aspect, the distance between a winding and the core (both the column and the core top and core bottom) should be substantially minimized. For example, the height of the winding may cover the height of the core column with a minimum space between the winding and the top and bottom parts of the core.

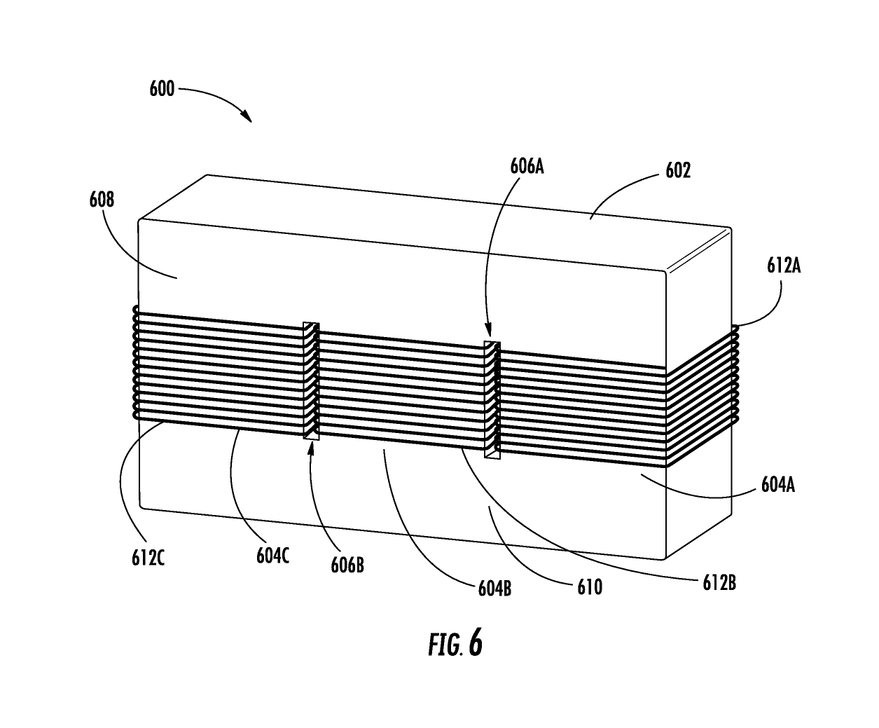

The latter two aspects may be achieved by keeping the distance between the different windings, and between the windings and the core, only as large as required for proper isolation. Example embodiments incorporating these latter two aspects are illustrated in FIGS. 6 and 7.

One example a parallel multi-winding magnetic structure 600 is illustrated in FIG. 6. The parallel multi-winding magnetic structure 600 includes a core 602 and windings 612A-C. The core includes columns 604A-C, a core top 608 and a core bottom 610. Opposing columns 604, the core top 608 and the core bottom 610 cooperatively define winding windows 606A, 606B (collectively, winding windows 606). For example, opposing columns 604A and 604B cooperatively define, in conjunction with the core top 608 and the core bottom 610, winding window 606A. Likewise, each winding 612A-C is wound around one of the columns 604A-C and passes through at least one winding window 606.

FIG. 7 illustrates a cross-sectional view of a portion of a parallel multi-winding magnetic structure 700 with a core 702 and windings 712 according to another example embodiment. The core 702 is similar to the core 602 in FIG. 6, but has a different number of winding windows (three of which are illustrated). The core 702 includes columns 704A, 704B and winding windows 706A-C. A core top 708 overlies the columns 704 and defines the top of the winding windows 706. The core bottom 710 underlies the columns 704 and defines the bottom of the winding windows 706. Winding 712A is wound around column 704A and passes through winding windows 706A and 706B. Winding 712B is wound around column 704B and passes through winding windows 706B and 706C.

As can be seen in FIGS. 6 and 7, each of the windings 612, 712 of the parallel multi-winding magnetic structures 600, 700 has a substantially minimized distance between adjacent windings 612A/612B, 612B/612C, 712A/712B, and has a substantially minimized distance between the windings 612, 712 and the core 602, 702. The windings 612, 712 occupy substantially all of the height of each winding window 606, 706 through which they pass. Further, different windings (e.g. windings 712A and 712B) passing through a same winding window (e.g., winding window 706B) are close together (i.e., exhibit a substantially minimized distance between the windings 712).

The incorporation of the aforementioned aspects in parallel multi-winding magnetic structures 600, 700 can be clearly seen by contrasting the parallel multi-winding magnetic structures 600, 700 with, for example, transformer 300 in FIG. 4. In transformer 300, the windings are separated from each other by a substantial distance.

According to another aspect of the present disclosure, a parallel multi-winding magnetic structure's windings are wound using an intercoil bifilar technique. This new winding technique may reduce the amount of energy in the uncoupled magnetic field and, therefore, may reduce the leakage inductance of the parallel multi-winding magnetic structure. Adjacent coils with multiple turns have their windings arranged in an alternating way (e.g., from top to bottom of a winding window, from side to side of a winding window, etc.). Using the intercoil bifilar technique, the windings may be alternated in a turn by turn fashion or may be alternated in groups of more than one turn. Various embodiments of parallel multi-winding magnetic structures incorporating this aspect are illustrated in FIGS. 8-11.

In FIG. 8, a parallel multi-winding magnetic structure 900 includes a core 902 and windings 912A-C. The core includes columns 904A-C, a core top 908 and a core bottom 910. Opposing columns 904, the core top 908 and the core bottom 910 cooperatively define winding windows 906A, 906B. Each winding 912A-C is wound around a column and passes through at least one winding window 906. As can be seen, each winding 912 alternates, on a turn-by-turn basis, with another winding 912 in their shared winding window 906. FIG. 9 is a cross sectional view of a portion of the parallel multi-winding magnetic structure 900 showing the core 902 and the windings 912A and 912B within the window 906A. Two magnetic fields 914 that would be generated by current flowing through winding 912A are also illustrated in FIG. 9. As can be seen, the intercoil bifilar winding may help reduce the volume of space occupied by a magnetic field that couples to only one winding.

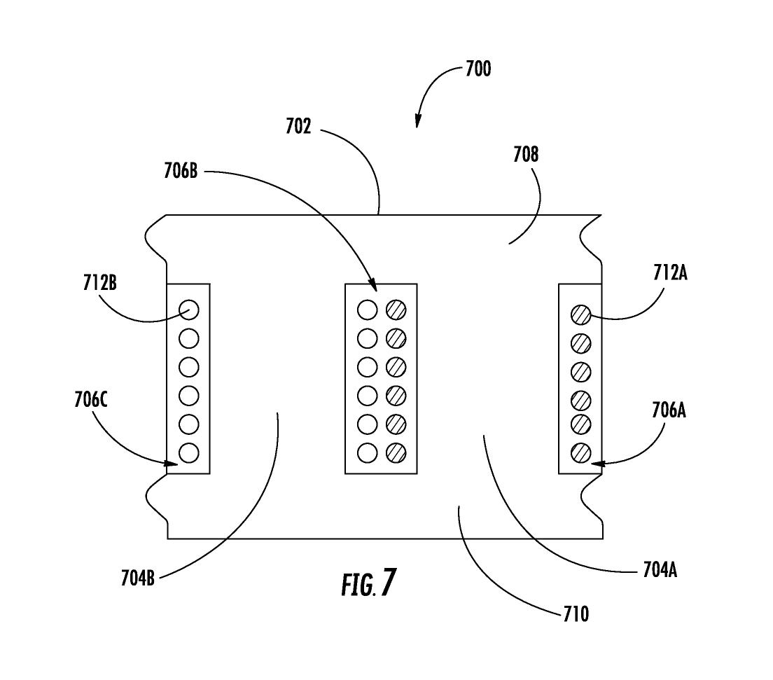

FIGS. 10 and 11 illustrate cross section portions of structures 1000, 1100 according to other example embodiments. The parallel multi-winding magnetic structures 1000, 1100 demonstrating some of the possible variations of the intercoil bifilar winding technique. In FIG. 10, the windings 1012A, 1012B of the parallel multi-winding magnetic structure 1000 alternate both from top to bottom of the winding window 1006, and also from side to side of the winding window 1006. The parallel multi-winding magnetic structure 1100 includes windings 1112A, 11128 that alternate from top to bottom of winding window 1106 in groups of two turns (instead of alternating on a turn-by-turn basis as occurs in the parallel multi-winding magnetic structure 1000 of FIGS. 8 and 9).

The example parallel multi-winding magnetic structures discussed above (e.g., 500, 600, 700, 900, 1000, 1100), have generally been illustrated and discussed with reference to three windings. However, the teachings disclosed herein (including those described above and below) may be used in parallel multi-winding magnetic structures having more than three windings. Some of the additional aspects of the present disclosure described hereinafter will be illustrated and/or discussed with reference to more than three windings. It should be understood that each of the aspects above and the aspects below may be utilized (individually or in any combination) for parallel multi-winding magnetic structures having any suitable number of windings.

According to still another aspect of the present disclosure, the volume of a parallel multi-winding magnetic structure occupied by the winding should be substantially minimized versus the volume of the core in the horizontal plane.

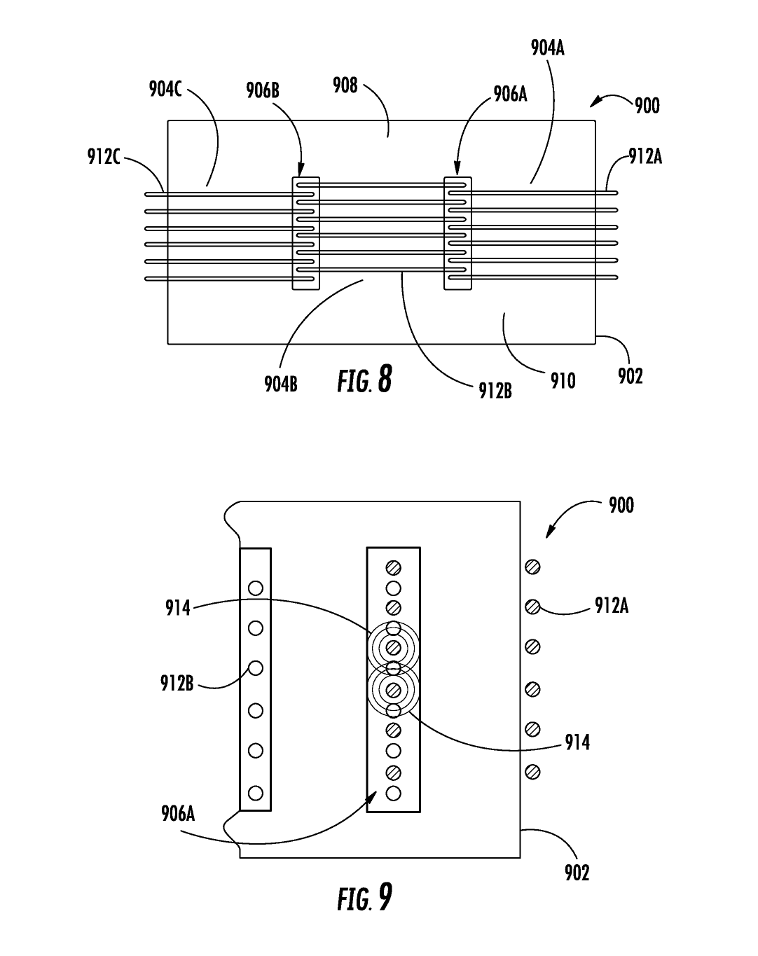

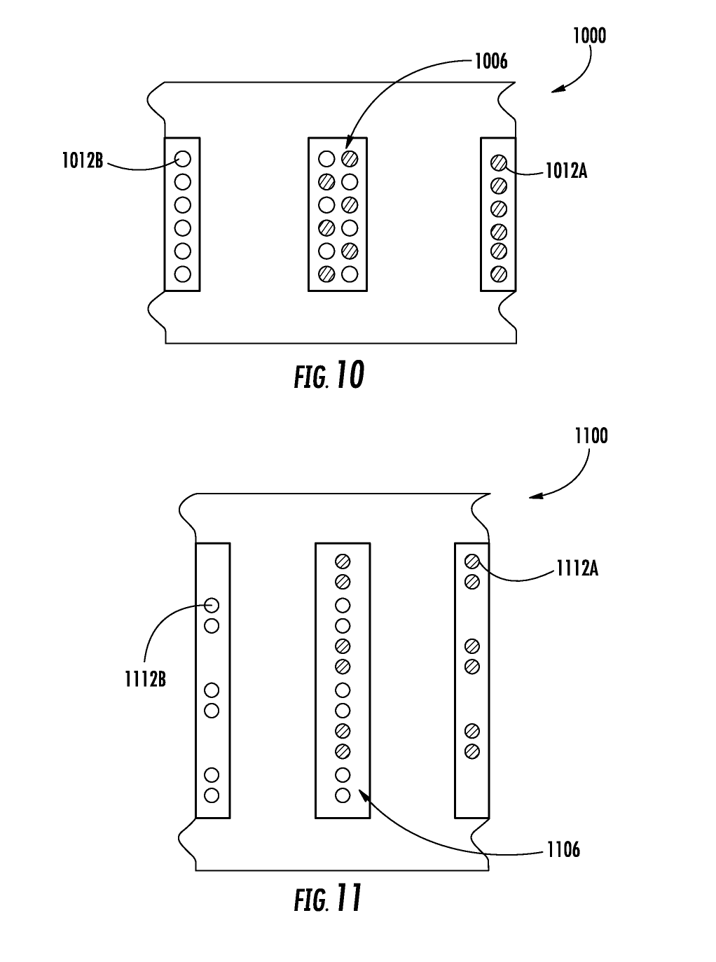

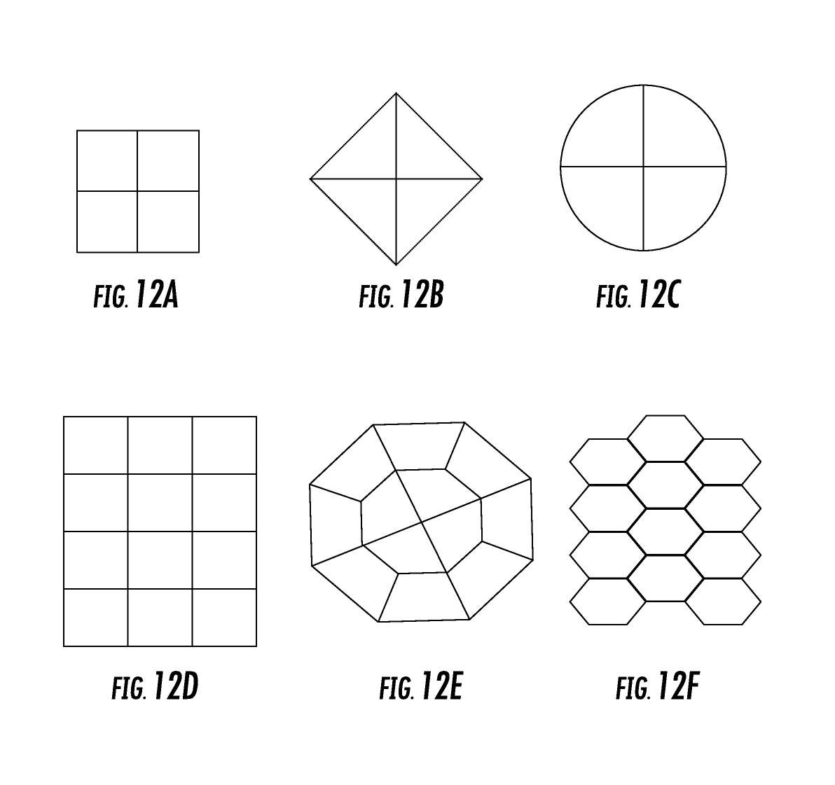

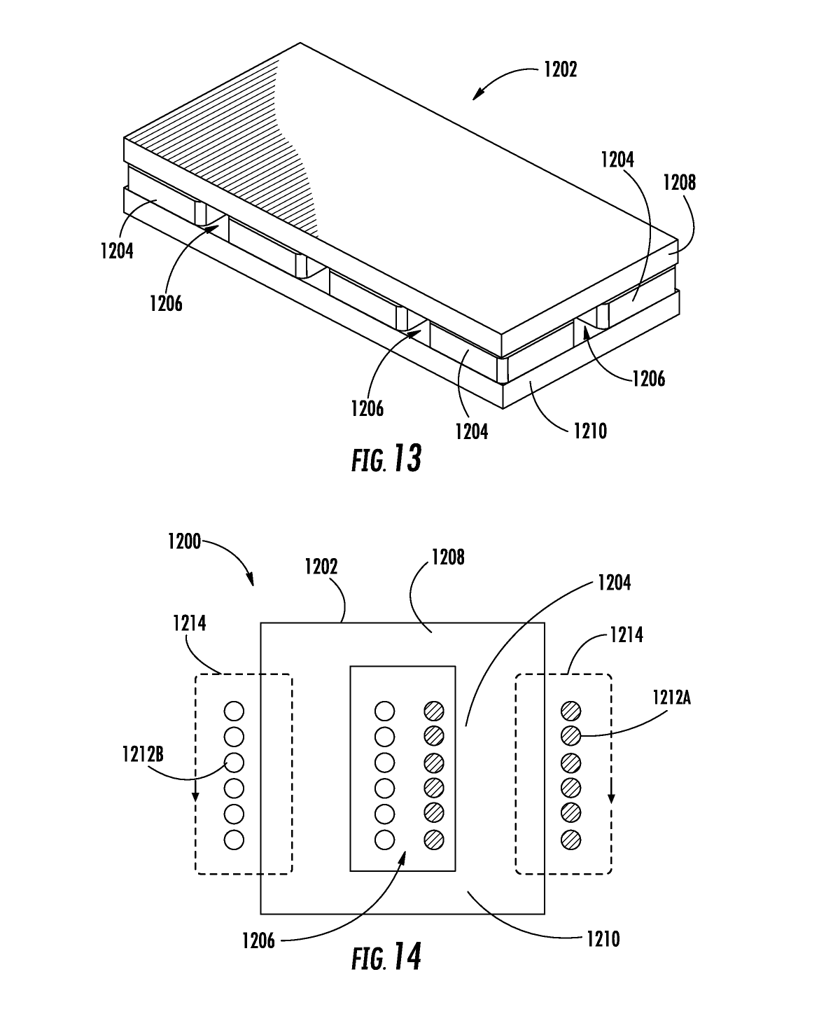

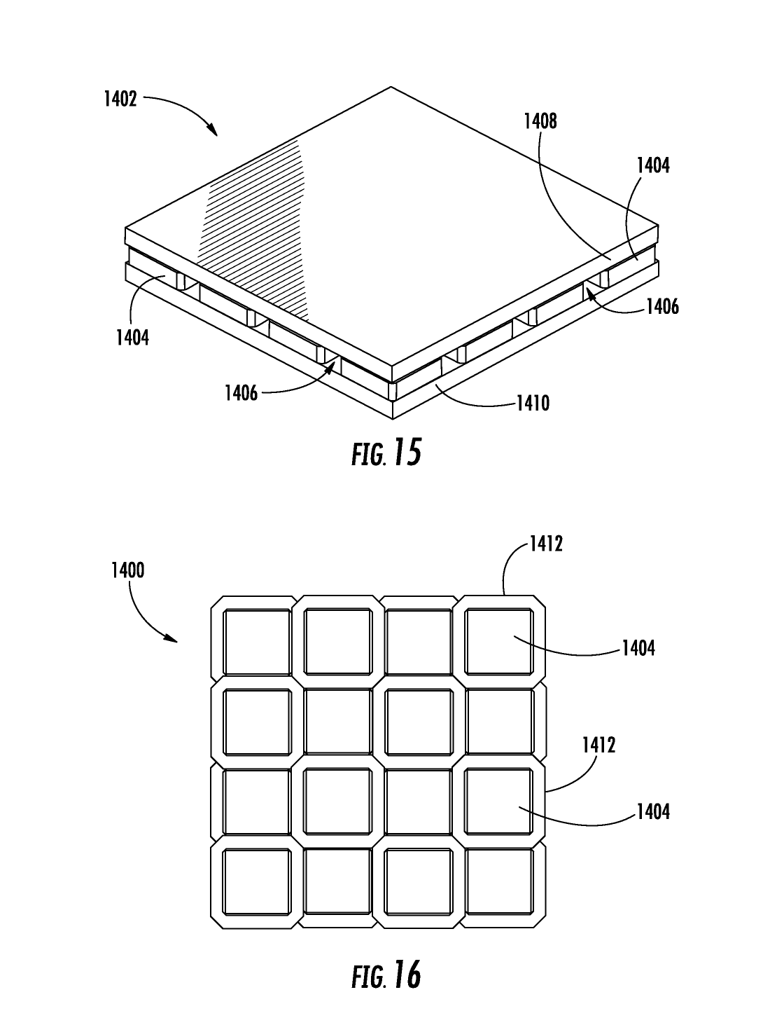

To achieve this, the overall area of the core in the horizontal plane may be divided between individual windings to maximize the ratio between the core area and the winding area. In other words, the length of the winding should be minimized for a given core area. This may be achieved if a linear arrangement (all windings in line, as shown for example in FIGS. 4-11) is replaced with a non-linear arrangement that places each winding in close proximity to all (or as many as possible) other windings. Several example embodiments illustrating configurations incorporating this aspect are illustrated in FIGS. 12A-12F. Each of FIGS. 12A-12C is a top plan view of a core (without a core top) for a four winding parallel multi-winding magnetic structures. In FIG. 12A, for example, the core is a square core having four square columns on which windings could be wound. Similarly, FIG. 12B is a square core with four triangular columns on which windings may be wound. FIG. 12C is a circular core having four pie-shaped columns. FIGS. 12D-12F illustrate example core configurations for twelve winding parallel multi-winding magnetic structures. Of course, more of fewer windings may be used in any particular application and other variations of configuration incorporating this aspect are within the scope of this disclosure. Other embodiments incorporating this aspect include the core 1202 of FIG. 13, the core 1402 of FIG. 15, and the core 1502 of FIG. 18.

In one example multi-winding magnetic structure incorporating this aspect, the structure includes a magnetic including a first column, a second column, and a third column. Each of the first, second and third columns has a center. The first and second columns are spaced apart from each other to define a first side and a second side of a first winding window between the first and second column. The third column is spaced from one of the first and second columns to define a first side and a second side of a second winding window between the third column and said one of the first and second columns. The first, second and third columns are positioned relative to each other such that a single straight line would not pass through the center of all three columns. The core includes a core top overlying the first, second and third columns and defining a top of the first and second winding windows. The core also includes a core bottom underlying the first, second and third columns and defining a bottom of the first and second winding windows. The multi-winding magnetic structure includes a first winding around the first column, a second winding around the second column, and a third winding around the third column.

According to yet another aspect, the magnetic field existing in top and bottom portions of the core of a parallel multi-winding magnetic structure should pass through the parts of the core inside the windings. The magnetic field in the space between the windings and outside the outline (e.g., the perimeter, outer edge, etc.) of the core should be substantially minimized. Example embodiments incorporating this aspect will be discussed with reference to FIGS. 13-17

To achieve this, the magnetic path reluctance on the outside perimeter of the core may be substantially maximized by not permitting the core top and core bottom to substantially overhang the outline of the core's winding columns. As a result, winding portions along the perimeter of the core (i.e., windings around the perimeter columns) are not covered by the core top and core bottom along the perimeter of the core. In one embodiment, the core top and core bottom overhang perimeter windings by less than half the width of a winding window through which the perimeter winding passes.

An example embodiment of a parallel multi-winding magnetic structure 1200 incorporating this aspect is illustrated in FIGS. 13 and 14. The parallel multi-winding magnetic structure 1200 includes a core 1202 having eight columns 1204 (five of which are visible in FIG. 13). The core includes the columns 1204, a core top 1208 and a core bottom 1210. Opposing columns 1204, the core top 1208 and the core bottom 1210 cooperatively define winding windows 1206. A winding 1212 is wound around each column 1204. To illustrate other features, the windings 1212 are not shown in FIG. 13. Two of the windings 1212A, 1212B are, however, illustrated in FIG. 14. Each winding 1212 is wound around a column 1204 and passes through at least one winding window 1206. In FIG. 14, it can be seen that the core top 1208 and core bottom 1210 do not overhang (or underhang) the windings 1212 at the perimeter of the parallel multi-winding magnetic structure 1200. Magnetic fields 1214 generated by current flowing through the windings 1212 are shown in FIG. 14. Because the core top 1208 and core bottom 1210 do not extend over/under the windings 1212, magnetic reluctance of the field path on the perimeter of the parallel multi-winding magnetic structure 1200 may be increased as compared to a core that does extend over/under its windings. This increased magnetic reluctance improves coupling between windings 1212 and reduce the leakage inductance of the structure 1200.

Another example parallel multi-winding magnetic structure 1400 is shown in FIGS. 15-17. The parallel multi-winding magnetic structure 1400 includes a core 1402 having sixteen columns 1404 (seven of which are visible in FIG. 15). The core 1402 includes the columns 1404, a core top 1408 and a core bottom 1410. Opposing columns 1404, the core top 1408 and the core bottom 1410 cooperatively define winding windows 1406. A winding 1412 is wound around each column 1404. The windings 1412 are not illustrated in FIG. 15. Each winding 1412 is wound around a column 1404 and passes through at least one winding window 1406. In FIG. 17, it can be seen that the core top 1408 and core bottom 1410 do not overhang the windings 1412 at the perimeter of the parallel multi-winding magnetic structure 1400.

The core top and/or core bottom of a parallel multi-winding magnetic structure may, additionally or alternatively, have their edges chamfered to help minimize the magnetic field in the space outside the core.

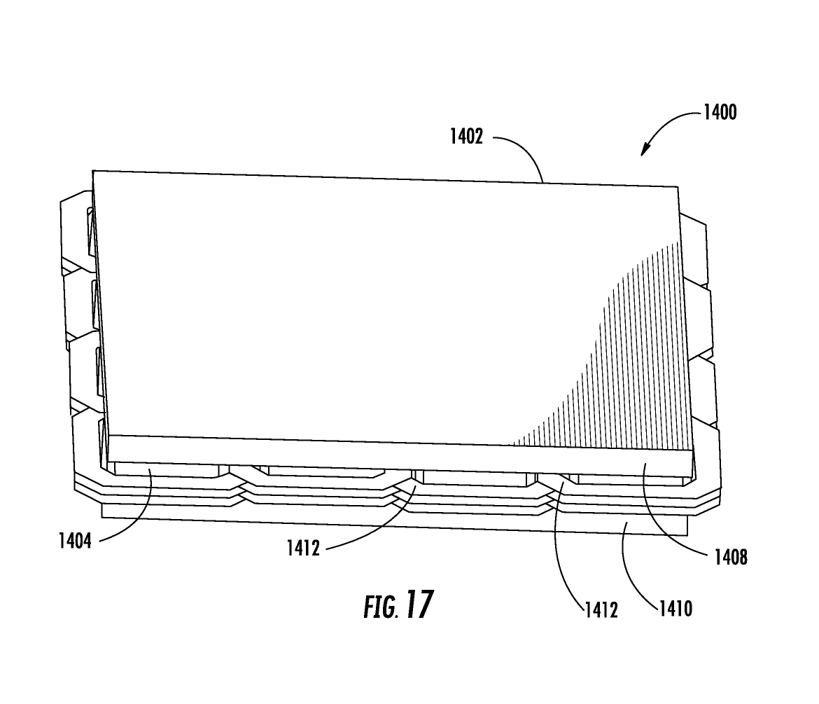

An example embodiment of a parallel multi-winding magnetic structure 1500 including a chamfered core top and a chamfered core bottom is illustrated in FIGS. 18-20. The parallel multi-winding magnetic structure 1500 includes a core 1502 having eight columns 1504. The core includes the columns 1504, a core top 1508 and a core bottom 1510. Opposing columns 1504, the core top 1508 and the core bottom 1510 cooperatively define winding windows 1506. A winding 1512 is wound around each column 1504. The windings 1512 are not illustrated in FIGS. 18 and 19. Two windings 1512A, 1512B are illustrated in FIG. 20. Each winding 1512 is wound around a column 1522 and passes through at least one winding window 1506.

The core top 1508 has a central section 1516 with a substantially constant thickness. The thickness of the central section 1516 generally defines the thickness of the core top 1508. The thickness of the core top 1508 decreases from a perimeter 1520 of the central section 1516 to an exterior edge 1522 of the core top 1508.

The core bottom 1510 has a central section 1518 with a substantially constant thickness. The thickness of the central section 1518 generally defines the thickness of the core bottom 1510. The thickness and chamfer of the core bottom 1510 may be the same as or different from the core top 1508. The thickness of the core bottom 1510 decreases from a perimeter 1524 of the central section 1518 to an exterior edge 1526 of the core bottom 1510.

Magnetic fields 1514 generated by current flowing through the windings 1512 are illustrated in FIG. 20. As compared with other structures, the volume of the uncoupled magnetic field 1514 the parallel multi-winding magnetic structure 1500 is reduced because the chamfering of the core top 1508 and core bottom 1510. The increased magnetic reluctance of the field path on the perimeter of the parallel multi-winding magnetic structure 1500 may improve coupling between the windings 1512 and reduce the leakage inductance of the parallel multi-winding magnetic structure 1500.

The core top and the core bottom may be chamfered at the same angle or at different angles. The angle at which the core top and the core bottom are chamfered may be any suitable angle. In some embodiments, the angle of the chamfer is at least fifteen degrees and less than about seventy-five degrees. The angle may be the same on all sides of a core top and/or core bottom. Alternatively one or more of the sides of a core top or core bottom may be chamfered at an angle different from one or more other sides. Although illustrated in the figures as a straight chamfer that decreases the thickness of the core top/bottom in a linear fashion, core top and core bottom may be chamfered in different profiles (e.g., a convex chamfer, etc.).

The core (e.g., 402, 502, 602, 702, 902, 1202, 1402, 1502) for any of parallel multi-winding magnetic structures disclosed herein may be made of any suitable magnetic material or materials including, for example, ferrite, iron powder, amorphous metal, laminated steel, laminated iron, carbonyl iron, soft iron, etc. The core may be monolithically formed (i.e., the core top, core bottom and columns may be a single piece of material) or the core may be constructed from two or more separate parts, layers, materials, etc. The magnetic material may be a single magnetic material, a composite material, etc.

Windings for any of parallel multi-winding magnetic structures disclosed herein (e.g., 500, 600, 700, 900, 1000, 1100, 1200, 1400, 1500), the windings may be made of any suitable materials. For example, the windings may be made from metal wire or from metal sheets (by, for example, cutting, stamping, etc.). The metal of the wire or sheets may be any suitable metal or combination of metals including, for example, copper. The windings may also be formed as traces on a printed circuit board or a flexible circuit. To produce more than one turn in a winding on a PCB, multiple layers may be used with conductive vias appropriately connecting traces on adjacent layers.

Also for all parallel multi-winding magnetic structures disclosed herein (e.g., 500, 600, 700, 900, 1000, 1100, 1200, 1400, 1500), the areas of individual windings may be the same or different. The number of turns of the individual windings may be the same or may be different. Individual windings may connect to separate circuits or be connected to each other in various combinations.

In embodiments including columns that are not located along the perimeter of the structure's core (e.g. parallel multi-winding magnetic structure 1400 in FIGS. 15-17), input/output connections to windings around the interior columns may be made via holes in the core top, the core bottom, or both.

The parallel multi-winding magnetic structures described herein (e.g., 500, 600, 700, 900, 1000, 1100, 1200, 1400, 1500) may be used for isolated and non-isolated applications. They may also be used for applications mainly concerned with transforming energy (e.g., transformers), energy storage (e.g., inductors), or both. The may also be designed to work with significant DC bias (e.g., to operate as chokes). The parallel multi-winding magnetic structures may contain a gap in the magnetic path or the gap may be omitted.

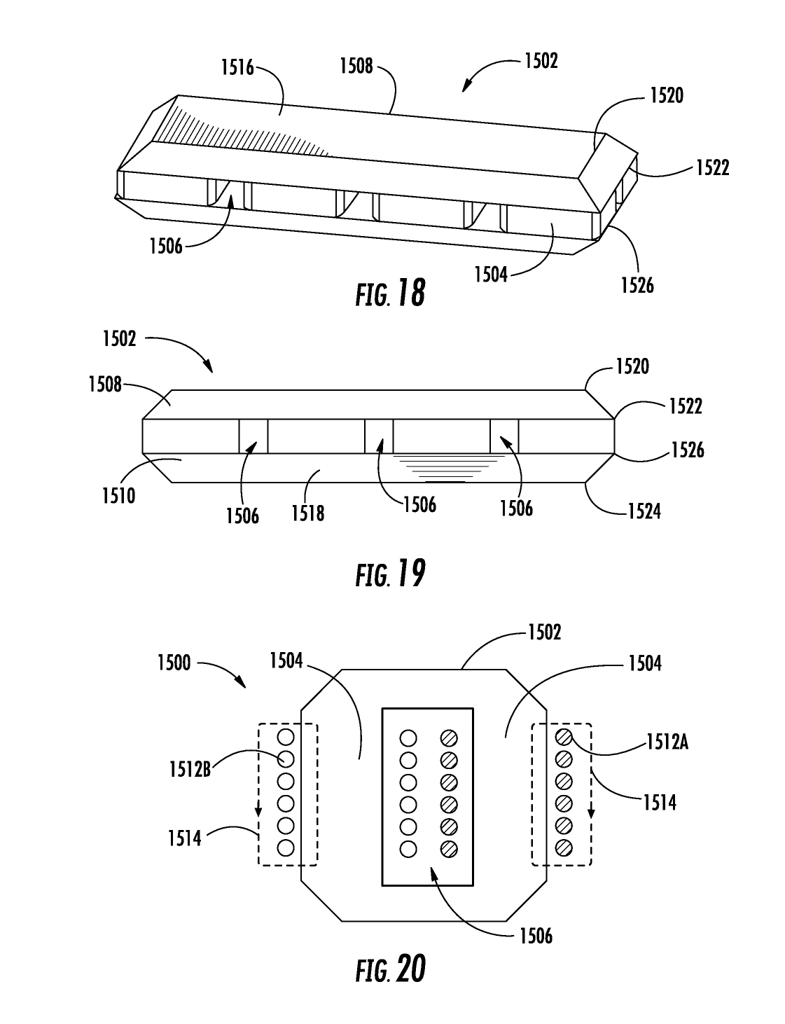

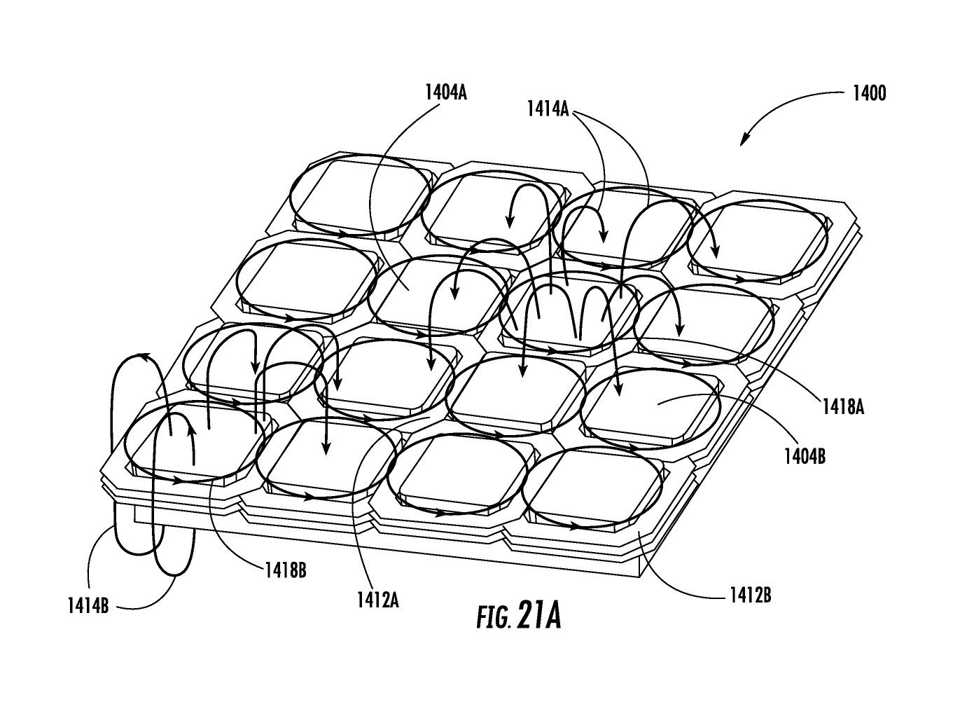

FIG. 21A illustrates the parallel multi-winding magnetic structure 1400 of FIGS. 15-17 illustrating magnetic fields. The structure 1400 includes interior columns 1404A having windings 1412A (i.e., interior windings) and exterior columns having windings 1412B (i.e., exterior windings). While the interior windings 1412A are surrounded by adjacent windings (e.g., adjacent interior windings 1412A or adjacent exterior windings 1412B), the exterior windings 14128 are only partially surrounded by adjacent windings.

When current 1418A, 14188 flows through the interior windings 1412A and exterior windings 1412B, magnetic fields are created. The magnetic fields (e.g., a magnetic field 1414A) in the interior columns 1404A have a closed path via adjacent interior columns. Those magnetic fields induce a voltage in adjacent interior windings that in turn generate an induced current in the adjacent interior windings. If the interior winding 1412A has low impedance, the induced current will generally match an induced current in an adjacent interior winding. Furthermore, although not shown, additional magnetic fields produced by the induced current in the adjacent interior windings will substantially cancel the originally produced magnetic fields (e.g., magnetic field 1414A), thus reducing flux density in the core.

Conversely, some portions of the magnetic fields (e.g., magnetic field 1414B) in the exterior columns 1404B (i.e., the portion of the magnetic field protruding away from the structure 1400) do not have a path via adjacent column(s). Those magnetic fields are uncoupled magnetic fields. Accordingly, the uncoupled magnetic fields (e.g., magnetic field 1414B) will not induce a voltage and current in adjacent windings and subsequently will not induce additional magnetic fields. Thus, some of the originally produced magnetic fields in the exterior columns 14048 will not be cancelled.

For clarity purposes, two lines of magnetic field 1414B of one exterior winding 1412B flowing through exterior column 1404B and eight lines of magnetic field 1414A of the interior winding 1412A flowing through interior column 1404A are illustrated. As should be apparent though, these lines represent magnetic fields generated for each exterior winding and each interior winding along the length of each respective winding.

Furthermore, the current 1418A flowing through each interior winding 1412A is in an opposite direction of the current flowing through the adjacent winding. This characteristic leads to current equalization and minimization of uncoupled magnetic fields (as described above). Conversely, as shown in FIG. 21A, portions of each exterior winding 1412B do not have an adjacent winding having current flowing in the opposite direction.

Moreover, a difference in amplitude of the current 1418A, 1418B flowing in the windings 1412A, 1412B may be realized. This difference violates the constant ampere-turn product rule (equation 3 above). The difference in current may be caused by imperfect coupling, differences in the amount of flux crossing between different windings, differences in the magnetic reluctance path leading through different windings (among others caused by different distances between windings) and/or differences in the area of the loop encompassed by each winding.

The uncoupled magnetic fields (e.g., magnetic field 1414B) is undesirable because: the constant ampere-turn product rule (equation 3 above) becomes less accurate, induced currents differ more significantly between various windings depending on their physical location versus the winding with the excitation current, a net AC flux density in the core is increased thus elevating core losses, energy is stored in the uncoupled magnetic fields thus contributing to leakage inductance in the structure, a bandwidth of a system employing the structure may be reduced, space adjacent the structure is filled with the uncoupled magnetic fields thus creating possible electromagnetic interference (hereinafter “EMI”) issues in a system employing the structure, air gaps may be needed to prevent excessive imbalances in the uncoupled magnetic fields distribution thus complicating manufacturing, and the size of the structure may have to be increased to allow handling of the imbalances in the uncoupled magnetic fields.

To reduce the effects of the difference in amplitude of current flowing in the windings and the uncoupled magnetic fields, an electrical conductor may be placed along the periphery of the structure. For example, a parallel multi-winding magnetic structure may include a magnetic core that defines a plurality of flux paths through the core and a plurality of windings extending around portions of the core. At least some of the windings are positioned adjacent a periphery of the structure. The structure further includes an electrical conductor extending along the periphery of the structure and the windings positioned adjacent the periphery of the structure.

FIG. 21B illustrates an example embodiment of a parallel multi-winding magnetic structure 2100. The structure 2100 employs the same core 1402 and winding 1412 configuration as illustrated in FIG. 17 and described above. An electrical conductor 2116 extends along the periphery of the structure 2100 and the windings 1412A positioned adjacent the periphery of the structure 2100. The electrical conductor 2116 may form a closed loop around the structure 2100.

As shown in FIG. 21B, each winding 1412 has a current (e.g., 2118A) flowing in an opposite direction of a current (e.g., 2118B) flowing in an adjacent winding. Additionally, the electrical conductor 2116 has a current 2118C flowing in an opposite direction of a current (e.g., 2118D) flowing in each winding 1412A positioned adjacent the periphery of the structure 2100. The amplitude of the current 2118C in the electrical conductor 2116 will approximately match that of the current in the windings 1412. Furthermore, because the structure 2100 is a parallel structure, current in all windings 1412 is approximately the same (assuming the same number of turns). Accordingly, the current 2118C in the electrical conductor 2116 will compensate the current of all windings 1412 on the periphery of the structure 2100.

The current flowing through each winding 1412 and the current 2118C flowing through the electrical conductor 2116 generate magnetic fields. For clarity purposes, two lines of magnetic field 2114 of one winding and two lines of magnetic field 2120 of the electrical conductor 2116 are illustrated. As should be apparent though, these lines represent magnetic fields generated for each winding and the electrical conductor along the length of each winding and the length of the electrical conductor. As shown in FIG. 21B, the magnetic field 2120 of the electrical conductor 2116 is flowing in an opposite direction than the magnetic fields 2114 of the windings 1412A positioned adjacent the periphery of the structure 2100. Thus, the magnetic field 2120 of the electrical conductor 2116 substantially cancels the magnetic fields 2114 of the windings 1412A.

The electrical conductor 2116 may be positioned as close as possible to the windings 1412A without making physical contact with the windings 1412A. Alternatively, the electrical conductor 2116 may be positioned at any suitable distance from the windings 1412A.

Additionally, the width of the electrical conductor 2116 may be the same as the width of the windings 1412. Alternatively, the electrical conductor 2116 may be wider or narrower than the windings 1412.

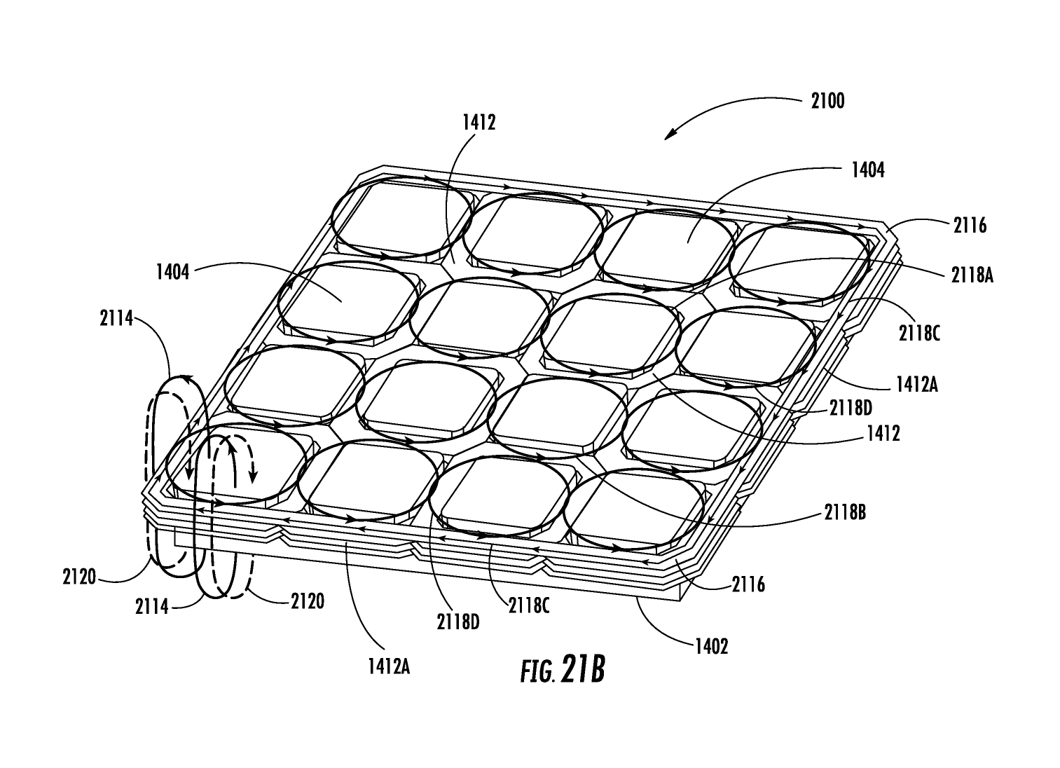

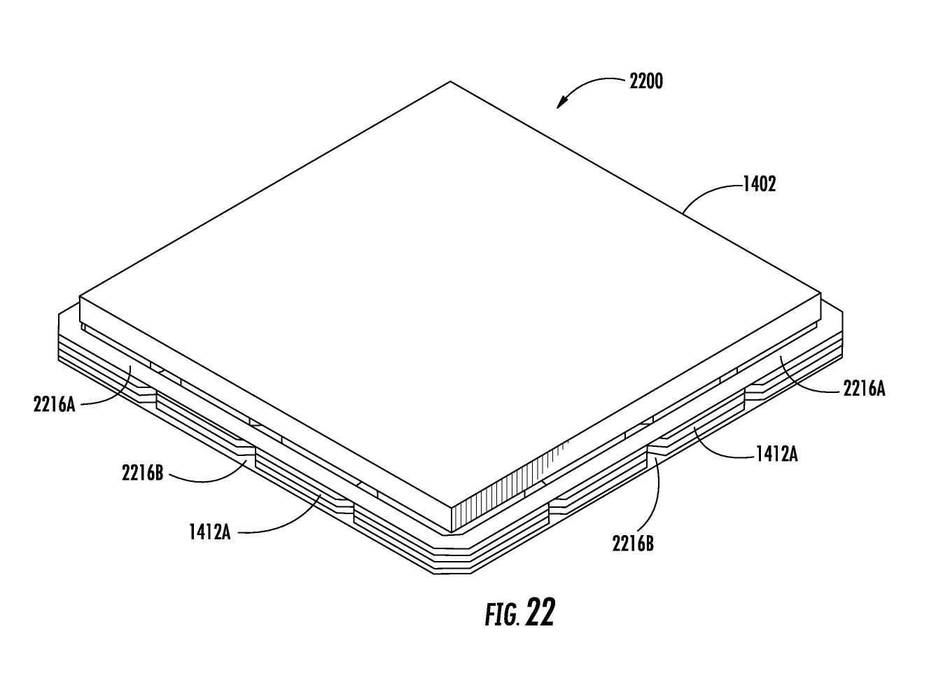

FIGS. 22 and 23 illustrate another example embodiment of a parallel multi-winding magnetic structure 2200. FIG. 23 is a portion of a cross sectional view of the structure 2200 of FIG. 22. The structure 2200 of FIGS. 22 and 23 employ similar core 1402 and winding 1412 configurations as illustrated in FIG. 21B and described above.

The structure 2200 further includes a plurality of electrical conductors 2216A, B extending along the periphery of the structure 2200 and the windings 1412A positioned adjacent the periphery of the structure 2200. As shown in FIGS. 22 and 23, the plurality of electrical conductors 2216A, B are separated from one another by the windings 1412A. That is, the windings 1412A are positioned between the electrical conductor 2216A and the electrical conductor 2216B. The electrical conductor 2216A and the electrical conductor 2216B may form parallel paths extending around the periphery of the structure 2200.

FIGS. 24-26 illustrate example embodiments of a portion of parallel multi-winding magnetic structures. Each structure of FIGS. 24-26 employ the same core 1402 configuration as illustrated in FIG. 21 and described above. As shown in FIGS. 24-26, each structure also includes a winding having a plurality of turns extending around portions of the core 1402. Each winding may employ similar winding configurations as illustrated in FIG. 21B and described above. However, as should be understood, each structure may include a plurality of windings having one or more turns.

FIG. 24 illustrates a portion of a parallel multi-winding magnetic structure 2400. As shown in FIG. 24, a plurality of electrical conductors 2416A-C are separated from one another by the winding 2412 positioned adjacent the periphery of the structure 2400. The winding 2412 is positioned between a top electrical conductor 2416A and a bottom electrical conductor 2416B. Furthermore, a middle electrical conductor 2416C is positioned between the turns of the winding 2412. Accordingly, the structure 2400 includes windings 2412 positioned adjacent the periphery of the structure 2400 each having multiple turns interleaved with the plurality of electrical conductors 2416A-C. Furthermore, as shown in FIG. 24, the plurality of electrical conductors 2416A-C are interleaved with all of the multiple turns of the windings (e.g., the winding 2412) positioned adjacent the periphery of the structure 2400. The plurality of electrical conductors 2416A-C interleaved with the windings 2412 may further reduce the amount of uncoupled magnetic fields present.

FIG. 25 illustrates a portion of a parallel multi-winding magnetic structure 2500. The structure 2500 may include a plurality of electrical conductors 2516A-D extending along the periphery of the structure 2500 and the windings 1412A positioned adjacent the periphery of the structure 2500. As shown in FIG. 25, the structure 2500 includes four electrical conductors 2516A-D, however more or less electrical conductors may be employed. For example, only three electrical conductors (e.g., electrical conductors 2516A-C or electrical conductors 2516A, B, D) may be employed.

The plurality of electrical conductors 2516A-D may be electrically connected to one another. For example, the conductors may be connected in series or in parallel along the entire length of the conductors or in one or more portions of the conductors. Additionally, the number of parallel and/or series paths may be the same around the entire periphery of the structure 2400 or it may vary.

As shown in FIG. 25, the plurality of electrical conductors 2516A-D includes electrical conductors 2516A, 2516B extending in a first plane and one or more electrical conductors 2516C, 2516D extending in a second plane that is perpendicular to the first plane. The electrical conductors extending in the first plane 2516A, 2516B may be electrically connected to one another by the one or more electrical conductors 2516C, 2516D extending in the second plane. Accordingly, the winding 1412A may be enclosed by the electrical conductors 2516A-D.

FIG. 26 illustrates a portion of a parallel multi-winding magnetic structure 2600. The structure 2600 may include a plurality of electrical conductors 2616A-D extending along the periphery of the structure 2600 and the windings 1412A positioned adjacent the periphery of the structure 2600. The plurality of electrical conductors 2616A-D includes electrical conductors 2616A, 2616B extending in a first plane and one or more electrical conductors 2616C, 2616D extending in a second plane that is perpendicular to the first plane. As shown in FIG. 26, the electrical conductors 2616A, 2616B extending in the first plane are positioned along a side surface of the structure 2600, and the one or more electrical conductors 2616C, 2616D extending in the second plane are positioned along a top or bottom surface of the structure 2600.

The electrical conductors 2616A-D may be physically attached to the structure 2600. For example, the electrical conductors 2616A, 26168 may be formed by covering portions of the structure 2600 surface with conductive material while the electrical conductors 2616C, 2616D may include inductive material that cover portions of the top or bottom surfaces of the structure 2600. Alternatively, the electrical conductors 2616A-D may be physically separated from the structure 2600.

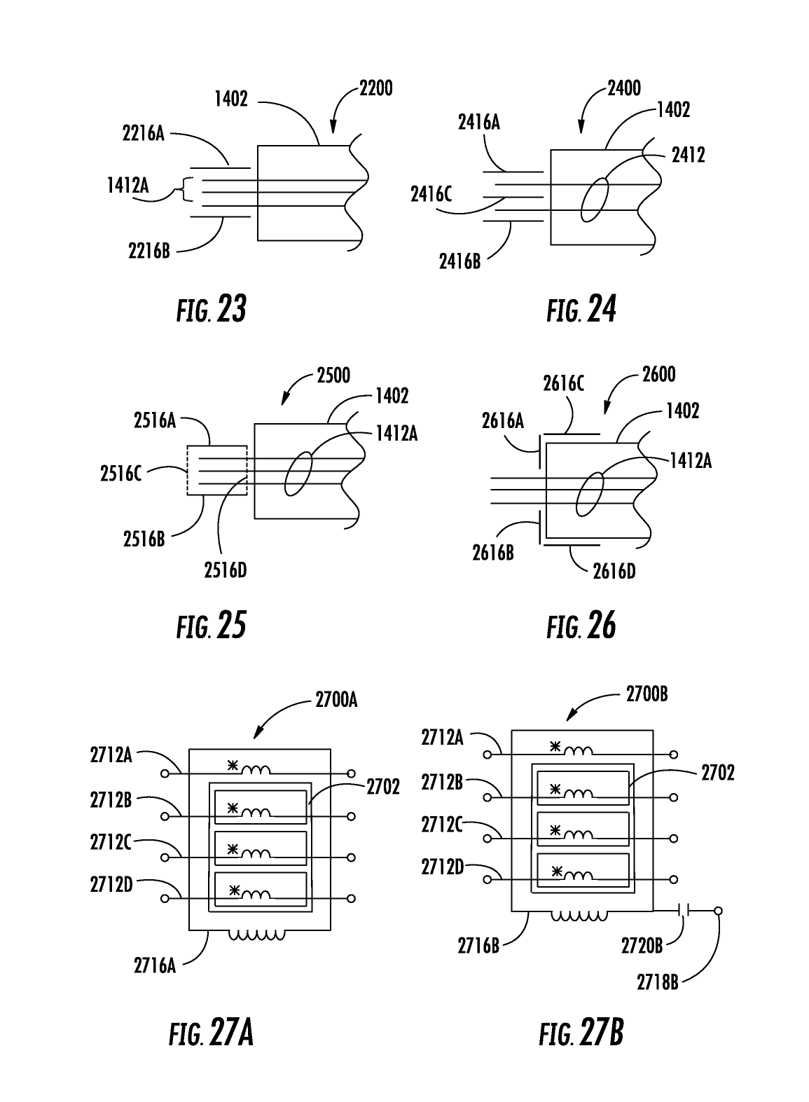

FIGS. 27A-31 illustrate example embodiments of parallel multi-winding magnetic structures. Each structure of FIGS. 27A-31 includes four windings 2712A-D and a core 2702. Each winding 2712A-D has an input and an output which may be determined by the direction in which the windings are wound on the core 2702. A star is used to indicate the input and the output orientation.

FIG. 27A illustrates a parallel multi-winding magnetic structure 2700A having a shorted electrical conductor 2716A. Accordingly, the electrical conductor 2716A may remain floating. The shorted electrical conductor 2716A is shown without a star because the electrical conductor 2716A is a continuous shorted loop having no beginning or end.

FIG. 27B illustrates a parallel multi-winding magnetic structure 2700B having an electrical conductor 2716B. As shown in FIG. 27B, the electrical conductor 2716B may be electrically connected to a reference voltage (via terminal 2718B). For example, the electrical conductor 2716B may be electrically connected to ground. Additionally, the electrical conductor 2716B may be electrically connected to the reference voltage via a capacitor 2720B. Accordingly, the electrical conductor 2716B may be configured as an electromagnetic shield and therefore reduce EMI.

FIG. 28 illustrates a parallel multi-winding magnetic structure 2800 having an electrical conductor 2816 that is non-continuous. Accordingly, the electrical conductor 2816 has opposite ends. As shown in FIG. 28, at least one of the opposite ends of the electrical conductor 2816 may be coupled to one or more circuit elements 2818. The circuit elements shown in FIG. 28 are merely examples of possible suitable circuit elements and therefore it should be apparent that any suitable circuit element may be employed as the one or more circuit elements 2818.

The one or more circuit elements 2818 may include passive and/or active circuits. Passive circuits may be used to form a desired frequency characteristic or time response for energy transfer of the structure 2800. Active circuits may be used to alter electric parameters (e.g., signals pertaining to windings 2712A-D) of the structure 2800.

Furthermore, the electrical conductor 2816 may act as a series magnetic structure with the totality of all windings 2712A-D while the windings 2712A-D still form a parallel magnetic structure.

FIG. 29 illustrates a parallel multi-winding magnetic structure 2900 having an electrical conductor 2916 that includes opposite ends for coupling to one or more circuit elements. The one or more circuit elements may include a filter 2918. As shown in FIG. 29, the filter 2918 includes a high pass filter that has a capacitor coupled between the opposite ends of the electrical conductor 2916 and an inductor coupled between each opposite end and a reference voltage (e.g., ground).

When the high pass filter is coupled to the electrical conductor 2916, the electrical conductor 2916 will function (as described above) only for frequencies above the roll-off frequency of the filter. For frequencies below the roll-off frequency, the reduction of uncoupled magnetic fields by electrical conductor 2916 will be reduced by additional impedance impeding flow of an induced current. As a result, leakage inductance of the structure 2900 will display frequency dependence corresponding to the frequency characteristic of the filter and the structure will function as if the electrical conductor 2916 is not present.

Although FIG. 29 illustrates a high pass filter having a particular configuration, other suitable high pass filter configurations may be employed, as can other suitable filters (e.g., low pass filters, band pass filters, band stop filters, etc.) without departing from scope of this disclosure.

FIG. 30 illustrates a parallel multi-winding magnetic structure 3000 having an electrical conductor 3016. The electrical conductor 3016 includes opposite ends for coupling to one or more circuit elements. As shown in FIG. 30, the one or more circuit elements includes a DC current source 3018. The DC current source 3018 may cancel DC current from the windings 2712A-D, reduce DC flux density in the core 2702 and/or reduce saturation of the core 2702. Furthermore, the DC current source 3018 may be used to pre-bias the core 2702 so that the core 2702 operates with a non-zero DC flux density.

Additionally, the one or more circuit elements may include a capacitor 3020 coupled between the opposite ends of the electrical conductor. The capacitor 3020 may provide a low impedance AC path to allow the electrical conductor 3016 to function as described above.

FIG. 31 illustrates a parallel multi-winding magnetic structure 3100 having an electrical conductor 3116. The electrical conductor 3116 includes opposite ends for coupling to one or more circuit elements. As shown in FIG. 31, the one or more circuit elements includes an AC voltage source 3118. The AC voltage source 3118 provides a voltage signal to each winding 2712A-D of the structure 3100. The voltage signal may be used to alter the voltage of the structure 3100.

Above are merely examples of one or more circuit elements which may be coupled to the electrical conductor. It should be apparent that any suitable circuit element may be employed without departing from scope of the present disclosure. Additionally, the circuit elements of FIGS. 28-31 or reference voltage of FIG. 27A may be coupled at any suitable location along the length of the electrical conductor.

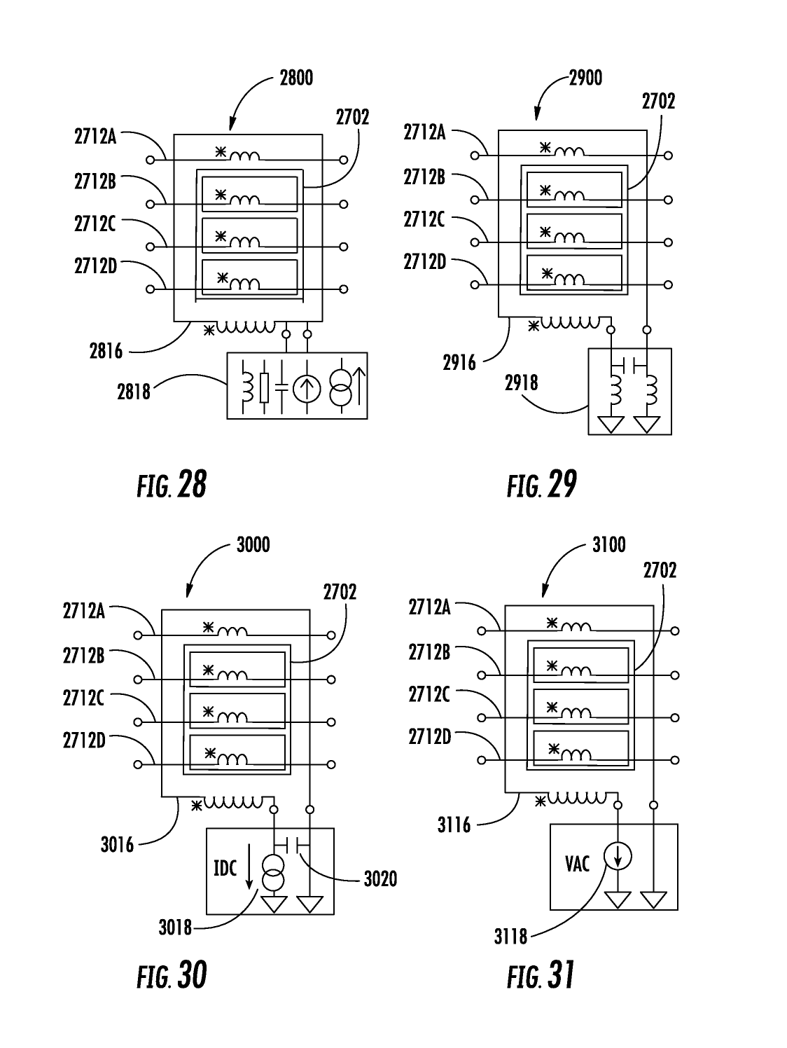

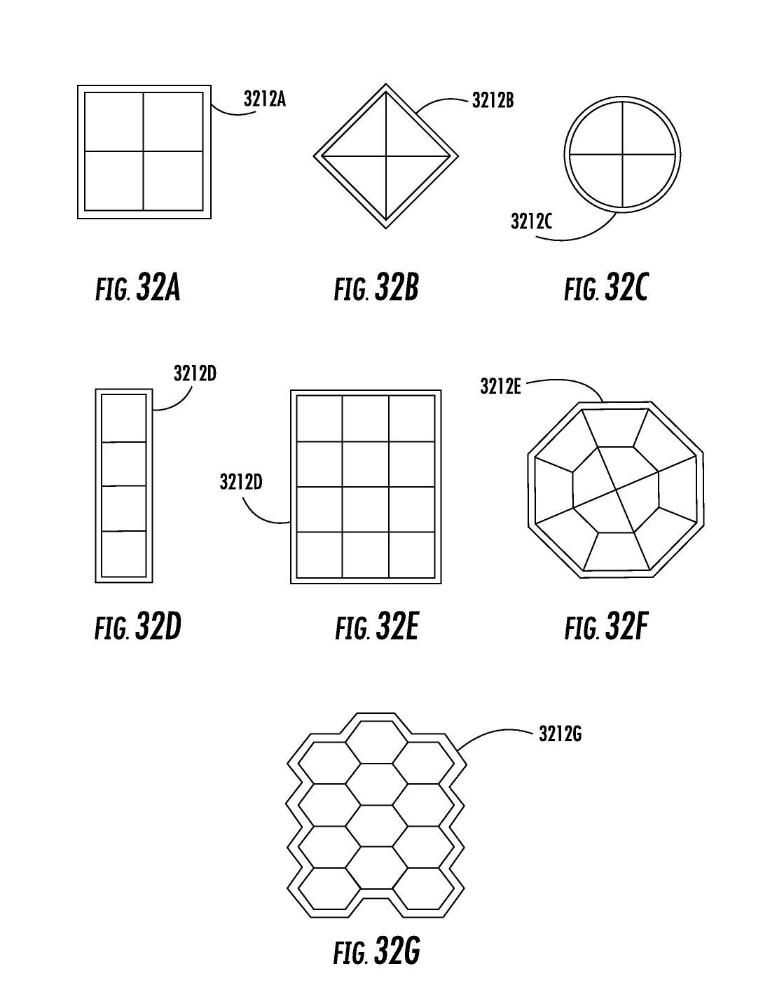

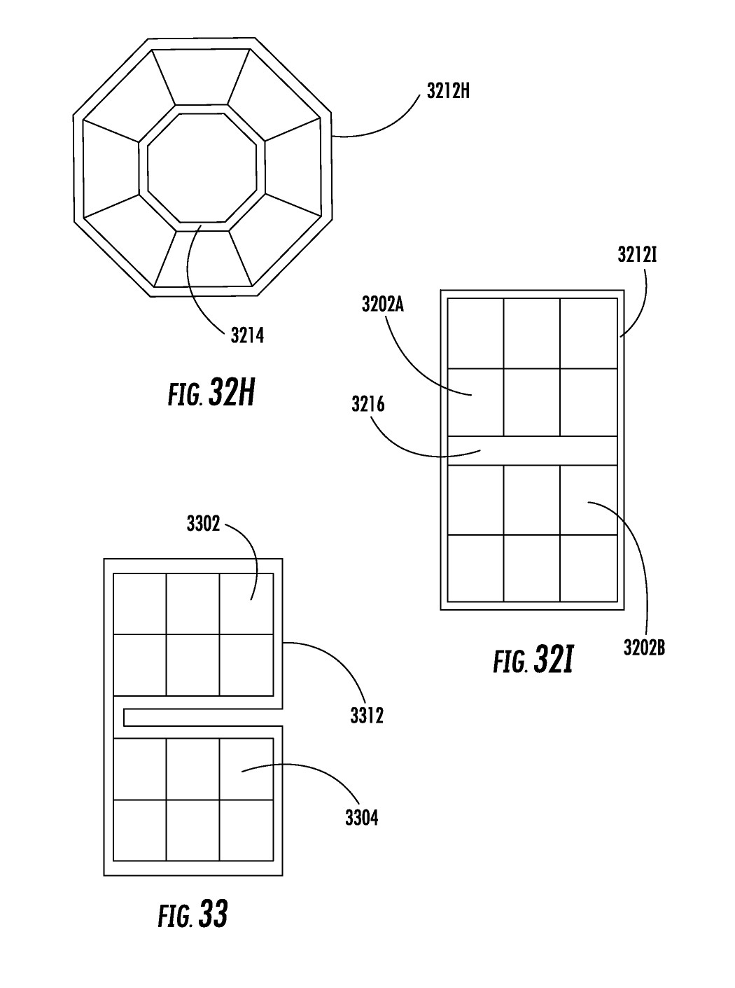

One or more electrical conductors may be employed in a structure having a linear arrangement or in a structure having a non-linear arrangement that places each winding in close proximity to all (or as many as possible) other windings. Several example embodiments illustrating configurations incorporating this aspect are illustrated in FIGS. 32A-32I. Each of FIGS. 32A-32I is a cross sectional view of a parallel multi-winding magnetic structure including one or more electrical conductors. As shown in FIGS. 32A-32I, one or more electrical conductors may extend along a periphery of the structure. For example, FIGS. 32A-32I illustrate an electrical conductor 3212A-3212I extending along an outer periphery of the structure.

Additionally and/or alternatively, one or more electrical conductors may extend along an inner periphery of the structure. For example, as shown in FIG. 32H, a structure includes an outer periphery and an inner periphery that has at least some windings positioned adjacent the inner periphery. A first electrical conductor 3212H extends along the outer periphery of the structure and a second electrical conductor 3214 extends along the inner periphery of the structure and the windings positioned adjacent the inner periphery of the structure. Accordingly, the first electrical conductor 3212H reduces the amount of uncoupled magnetic fields along the outer periphery and the second electrical conductor 3214 reduces the amount of uncoupled magnetic fields along the inner periphery.

The first electrical conductor 3212H extending along the outer periphery of the structure may be electrically connected to the second electrical conductor 3214 extending along the inner periphery of the structure. The first and second electrical conductors 3212H, 3214 may be electrically connected in series or in parallel along the entire length of the conductors or in one or more portions of the conductors.

FIG. 32I illustrates a structure having a core that includes a first portion 3202A and a second portion 3202B separated from the first portion 3202A by an air gap 3216. The structure further includes an electrical conductor 3212I that extends along opposing sides of the air gap 3216. As shown in FIG. 32I, the electrical conductor 3212I encompasses the core by traversing the air gap 3216 formed between the first and second portions 3202A, 3202B. By traversing the air gap 3216, uncoupled magnetic fields within the air gap 3216 may not be reduced by the electrical conductor.

Alternatively, two separate parallel multi-winding magnetic structures may by coupled together by an electrical conductor configured similar to the electrical conductor shown in FIG. 32I and described above.

FIG. 33 illustrates two separate parallel multi-winding magnetic structures 3302, 3304 that are encompassed by an electrical conductor 3312. The structures 3302, 3304 may have no direct magnetic link. As shown in FIG. 33, the electrical conductor 3312 extends adjacent to all sides of the structures 3302, 3304.

The plurality of windings as described above with reference to FIGS. 21-33 may be any suitable number of windings having any suitable number of turns so long as the number of windings is at least three. Accordingly, three or more windings (including four windings, twelve windings, etc.) having any suitable number of turns may be employed without departing from the scope of this disclosure.

Additionally, the plurality of windings as described above may be planar windings. Alternatively, the windings may be any suitable winding without departing from the scope of the present disclosure.

In addition, the electrical conductors and the plurality of windings as described above with reference to FIGS. 21-33 may be formed on a circuit board having one or more layers. Alternatively, the electrical conductors and the plurality of windings may be formed on any suitable surface or supported by any suitable surface.

Furthermore, one or more electrical conductors as illustrated in FIGS. 21-33 and described above may be employed with one or more features of the parallel multi-winding magnetic structures described above, including the various features shown in FIGS. 4-20.

Any one or more parallel multi-winding magnetic structure having an electrical conductor extending along a periphery of the structure may be employed in any suitable power converter such as multi-level parallel power converters or etc. U.S. patent application Ser. No. 13/093,415 (filed Apr. 25, 2011), which is incorporated herein by reference in its entirety, discloses example multi-level parallel power converters that may employ the structures.

Parallel multi-winding magnetic structures having an electrical conductor may reduce leakage inductance of the structure, reduce flux density in the core of the structure, reduce core losses of the structure, increase bandwidth of the converter employing the structure, improve current balance between the windings, reduce external or parasitic magnetic fields that create EMI, reduce the size of structure, and/or reduce or possibly eliminate an air gap in the structure.

A multi-level parallel power converter employing the structures having an electrical conductor may increase regulation bandwidth, increase efficiency, increase output voltage accuracy, reduce the size of the converter, simplify the manufacturing process, and/or reduce electromagnetic disturbance.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A parallel multi-winding magnetic structure comprising:
a magnetic core defining a plurality of flux paths through the core;
a plurality of windings extending around portions of the core, at least some of the windings positioned adjacent a periphery of the structure; and
an electrical conductor extending along the periphery of the structure and the windings positioned adjacent the periphery of the structure.

2. The structure of claim 1 wherein the structure includes a plurality of electrical conductors extending along the periphery of the structure and the windings positioned adjacent the periphery of the structure.

3. The structure of claim 2 wherein the plurality of electrical conductors are separated from one another by the windings positioned adjacent the periphery of the structure.

4. The structure of claim 3 wherein the windings positioned adjacent the periphery of the structure each have multiple turns interleaved with the plurality of electrical conductors.

5. The structure of claim 4 wherein the plurality of electrical conductors are interleaved with all of the multiple turns of the windings positioned adjacent the periphery of the structure.

6. The structure of claim 2 wherein the plurality of electrical conductors are electrically connected to one another.

7. The structure of claim 6 wherein the plurality of electrical conductors include electrical conductors extending in a first plane and one or more electrical conductors extending in a second plane that is perpendicular to the first plane.

8. The structure of claim 7 wherein the electrical conductors extending in the first plane are electrically connected to one another by the one or more electrical conductors extending in the second plane.

9. The structure of claim 7 wherein the electrical conductors extending in the first plane are positioned along a side surface of the structure, and the one or more electrical conductors extending in the second plane are positioned along a top or bottom surface of the structure.

10. The structure of claim 1 wherein the periphery is an outer periphery of the structure.

11. The structure of claim 10 wherein the electrical conductor is a first electrical conductor, the structure includes an inner periphery, and at least some of the windings are positioned adjacent the inner periphery of the structure, further comprising a second electrical conductor extending along the inner periphery of the structure and the windings positioned adjacent the inner periphery of the structure.

12. The structure of claim 11 wherein the electrical conductor extending along the outer periphery of the structure is electrically connected to the electrical conductor extending along the inner periphery of the structure.

13. The structure of claim 1 wherein the periphery is an inner periphery of the structure.

14. The structure of claim 1 wherein the core includes a first portion and a second portion separated from the first portion by an air gap, and the electrical conductor extends along opposing sides of the air gap.

15. The structure of claim 1 wherein the electrical conductor forms a closed loop.

16. The structure of claim 1 wherein the electrical conductor is electrically connected to a reference voltage.

17. The structure of claim 16 wherein the electrical conductor is electrically connected to the reference voltage via a capacitor.

18. The structure of claim 1 wherein the electrical conductor has opposite ends and at least one of the opposite ends is coupled to one or more circuit elements.

19. The structure of claim 18 wherein the one or more circuit elements includes a filter.

20. The structure of claim 18 wherein the one or more circuit elements includes a DC current source.

21. The structure of claim 18 wherein the one or more circuit elements includes an AC voltage source.

22. The structure of claim 18 wherein the one or more circuit elements includes a capacitor coupled between the opposite ends of the electrical conductor.

23. The structure of claim 1 wherein the electrical conductor and the plurality of windings are formed on a circuit board having one or more layers.

24. The structure of claim 1 wherein the plurality of windings is equal to four windings.

25. The structure of claim 1 wherein the plurality of windings is equal to twelve windings.

26. The structure of claim 1 wherein the plurality of windings are planar windings.
